(19) United States
(12) Patent Application Publication
(10) Pub. No.: US 2004/0021250 A1
(43) Pub. Date: Feb. 5, 2004

(54) Method of manufacturing a sheet-molded compound article having localized reinforcement

(76) Inventors: Dale F. Obeshaw, Salt Lake City, UT (US); Guy Krowl, Madison Heights, MI (US); Robin Westberg, Copperton, UT (US)

Correspondence Address: Welsh & Katz, Ltd., Eric D. Cohen, 22nd Floor, 120 South Riverside Plaza, Chicago, IL, 60606, US

(21) Appl. No.: 10/210,635

(22) Filed: Jul. 31, 2002

(51) Int. Cl. B29C 70/46

(52) U.S. Cl. 264/257; 264/258

(57) ABSTRACT

A method of manufacturing a sheet-molded compound (SMC) article having local reinforcement includes the steps of providing a mold for forming the SMC article, filling a portion of the mold with a chopped fiber compound and placing at least one filament-wound reinforcing element in a position in the mold where structural reinforcement of the SMC article is needed. The reinforcing element is formed by winding a resin-coated filament on a mandrel to form coils along a length of the mandrel, where each coil is wound at a predetermined angle relative to an axis of the mandrel. Heat and pressure are applied to the mold to cause the chopped fiber compound to melt such that the melted chopped fiber compound bonds with the reinforcing elements to form the SMC article with local reinforcement. The SMC article with local reinforcement is then removed from the mold.

### FIELD OF THE INVENTION

The present invention relates generally to a method for manufacturing a molded article, such as a vehicle body panel, and more specifically to a method for manufacturing a sheet-molded compound article with local reinforcement.

### BACKGROUND

Sheet molding compound (SMC) techniques for fabricating molded articles are known. This method is extensively used in the automobile industry where various interior and exterior panels or other structures are formed using SMC molding techniques. Generally, SMC material, such as chopped fiber compound, is made from polyester resin or vinyl-ester resin, and may have filler material, such as calcium carbonate. The SMC material is placed in a suitably shaped mold, and heat and pressure are applied to the SMC material causing it to liquefy and flow, thus assuming the shape or contour of the inside of the mold. Once the SMC material has solidified, it is removed from the mold and trimmed accordingly to provide the molded article. Various automotive components are formed in this manner.

The SMC molding process is fairly mature and cost effective. For example, an automobile hood or hood component may be able to be manufactured for about $200. Automobile components made using the SMC molding process are often subject to uneven forces and stresses directed to various portions of the article. For example, due to its shape, an automobile hood may be required to be stronger at its center point than at its edges. To permit the SMC molded article to withstand the maxinum forces for which it is designed, such articles are often “over-built” by increasing the overall thickness or mass of the product. This adds unnecessary weight to the final product due to the increase in the amount of SMC material used. This also adds unnecessary cost. If the SMC product is not sufficiently over-built, the product may under-perform.

In more exotic and expensive applications, such components may be formed of high-strength material, such as carbon fiber reinforced fabric or continuously wound glass/Kevlar fiber material. Although such products are extremely strong and light-weight, and satisfy the structural requirements of the article, it is generally prohibitively expensive to use articles made completely of such exotic materials in typical consumer vehicle panels and components.

### SUMMARY

The disadvantages of present sheet-molded compound components are substantially overcome with the present invention by providing a novel method of manufacturing sheet-molded compound components having localized reinforcement.

More specifically, one embodiment of a method of manufacturing a sheet-molded compound (SMC) article having local reinforcement includes the steps of providing a mold for forming the SMC article, filling a portion of the mold with a chopped fiber compound and placing at least one filament-wound reinforcing element in a position in the mold where structural reinforcement of the SMC article is needed. The reinforcing element is made by winding a resin-coated filament on a mandrel at predetermined angles. After winding is complete, the material is removed from the mandrel, cut to the desired shape and placed in the mold at the desired location along with the SMC charge. Heat and pressure are applied to the mold to cause the chopped fiber compound to melt such that the melted chopped fiber compound bonds with the reinforcing element to form the SMC article with local reinforcement. The SMC article with local reinforcement is then removed from the mold.

### BRIEF DESCRIPTION OF THE DRAWINGS

The features of the present invention which are believed to be novel are set forth with particularity in the appended claims. The invention, together with further objects and advantages thereof, may best be understood by reference to the following description in conjunction with the accompanying drawings.

FIG. 1 is a pictorial view of a specific embodiment of an apparatus for manufacturing a continuous fiber pre-form, according to the present invention;

FIGS. 2A-2C are side elevational views of specific filament coils wound about a mandrel at different angles;

FIG. 3 is a side elevational view of a specific embodiment of top and bottom portions of a mold;

FIG. 4 is a top plan view of a portion of the mold of FIG. 3;

FIGS. 5A-5B are side elevational views of specific illustrations of alternate embodiments of a mandrel;

FIG. 5C is a side elevational view of a continuous fiber pre-form sheet formed on the mandrel of FIG. 5B;

FIG. 6 is a perspective view of a specific embodiment of a panel; and

FIG. 7 is an enlarged perspective view of a selected continuous fiber pre-form section of FIG. 6.

### DETAILED DESCRIPTION

In this written description, the use of the disjunctive is intended to include the conjunctive. The use of definite or indefinite articles in not intended to indicate cardinality. In particular, a reference to “the” object or thing or “an” object or “a” thing is intended to also describe a plurality of such objects or things.

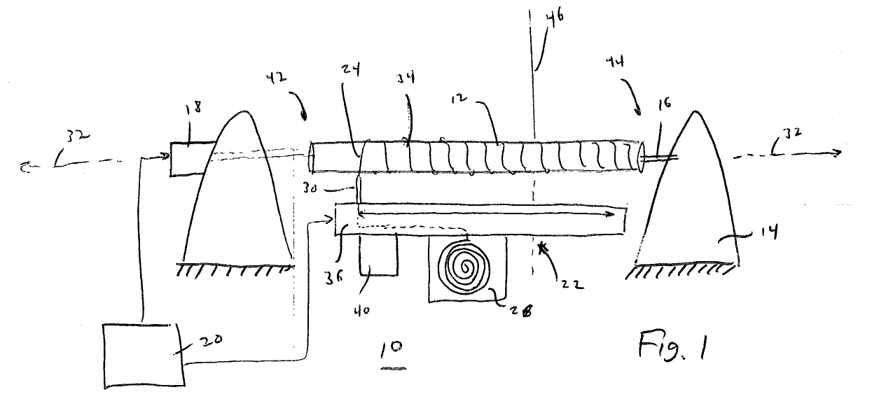

Referring now to FIG. 1, an apparatus 10 for manufacturing a continuous fiber pre-form is shown generally in schematic format. The apparatus 10 may utilize components that are known in the art. The apparatus may include a cylindrical mandrel 12 supported between a pair of mounts 14 by an axle 16 or other suitable support. The mandrel may be non-cylindrical also. For example, to facilitate winding flat pre-forms, the mandrel may be flat with arbors on each end to be held by the winder. Alternatively, the mandrel may be of some more complicated shape such that the individual pre-form, when cut, matches the shape the component to be manufactured. A motor 18 provides power to rotate the mandrel 12. The apparatus 10 is preferably a computer numerically controlled (CNC) device, and thus includes a computer or controller 20. Such an apparatus may be, for example, a Model 5K30-072-4-1 manufactured by Entec Composite Machines, Inc. The mandrel 12 may be, for example, five to ten feet or greater in length, and twenty-four inches in diameter. However, the mandrel 12 may be of any suitable dimension depending upon the application and size of the form produced.

Also included is filament winding portion 22, which accepts a continuous length of filament or “tow” 24, which may be supplied on a spool 26. The filament 24 may be e/glass fibers, glass fibers, fiberglass fabric strip, carbon fiber, Kevlar fiber, or any material having suitable strength characteristics. Typically, an individual fiber may be between 0.005 inches to 0.016 inches in diameter, but any suitable fiber diameter may be used. Carbon fiber filament may, for example, be “24K tow,” meaning that the filament is formed of 24,000 individual carbon fibers. The diameter of the filament or tow may be 0.2 inches but may spread to a width of 1 inch and having a thickness of 0.01 inches when wound onto the mandrel with resin.

The filament 24 is wound evenly over the length of the mandrel 12 as the mandrel turns. A spacing arm 30 controls the position of the filament 24 along a longitudinal axis 32 of the mandrel, and lays down the filament in the form of a coil 34 as the mandrel rotates. The winding pattern may include multiple “circuits” where the filaments pass over each other such that when the final circuit is wound, the resulting material on the mandrel has a uniform thickness at all locations. This may also be performed using winding patterns other than circumferential winding patterns. The number of times the filaments pass over one another can be varied according to how the winding pattern is programmed. This can provide a benefit in stabilizing the position and angle of the fibers during removal from the mandrel and cutting into local reinforcements for the sheet-molded compound “charge” (the chopped fiber compound placed in the mold), as described below.

The filament 24 is first coated with a resin before it is wound on the mandrel 12. The filament 24 may pass through a resin applicator or extruder 36 or other device that applies an appropriate amount of resin to the filament. The resin applicator 38 may be connected to a resin reservoir 40, which may, for example, contain an epoxy, vinyl-ester, or polyester liquid resin. However, any suitable resin may be used, as is known in the art. Further, the reservoir 40 may contain solid resin or resin pellets that may be melted on demand by the resin applicator 36.

The spacing arm 30 traverses the mandrel from end to end forming a layer of coated coiled filament. When the spacing arm 30 reaches a first end 42 of the mandrel 12, its direction of travel is reversed by the controller 20, and it continues to wind the filament on the mandrel in the opposite direction, thus applying another layer, until it reaches a second end 44 of the mandrel. This is repeated to form multiple layers of the filament coils 34. The resin coating bonds adjacent layers and tows together during curing. Preferably, the spacing arm 30 may be configured to wind the filament 24 on the mandrel 12 at a selected angle, as directed by the controller 20.

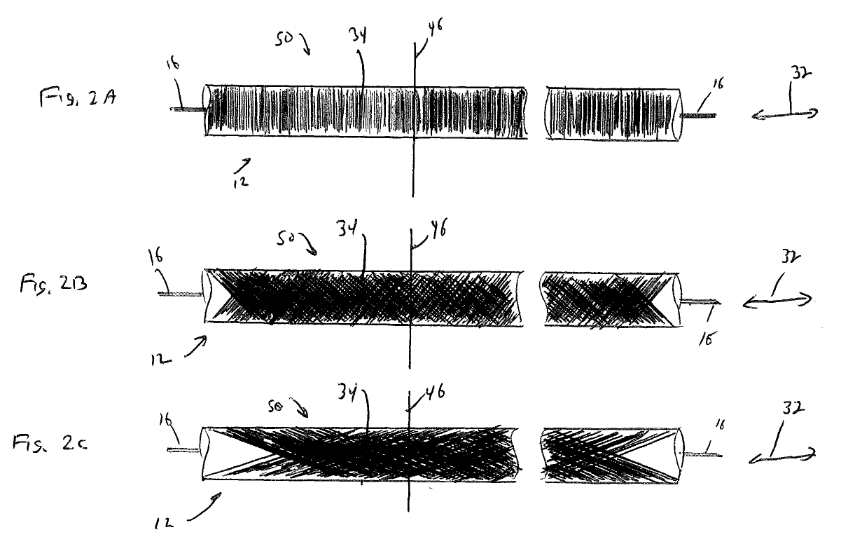

Referring now to FIGS. 1 and 2A-2C, FIGS. 2A-2C show pictorial views of the mandrel 12 after several layers of filament coils 34 have been wound. The spacing arm 30 in conjunction with the other components of the apparatus 10 may control the direction of application of the filament on the mandrel 12. For example, as specifically shown in the embodiment of FIG. 2A, the filament 24 may be wound at an angle of near zero degrees relative to a perpendicular axis 46, which perpendicular axis is ninety degrees relative to the longitudinal axis 32 of the mandrel 12. Using an angle of near zero degrees relative to the perpendicular axis 46, parallel coils 34 are wound about the mandrel 12, much in the same was as wire is wound on a spool. Such material wound at an angle of near zero degrees is very strong relative to forces applied along the perpendicular axis 46, but relatively weak along its longitudinal axis 32, as the coils may easily cleave between adjacent coils.

However, under control of the controller 20 (or under manual control), the angle of application of the filament 24 may be varied from about plus or minus seven degrees to about plus or minus eighty-nine degrees relative to the mandrel axis (longitudinal axis). Of course, the maximum angle achieved depends upon the length of the mandrel 12 relative to the diameter of the mandrel, and upon the type and gauge of the filament. Winding small angles (such as angles approaching the longitudinal axis 32 of the mandrel), although more difficult to wind than larger angles, may nonetheless be wound. When winding the filament using such small angles, “end-cap” (not shown) adapters or “pin rings” may be used to prevent the ends of the winding from slipping off the mandrel 12 during the transition from one layer to the next, as is known in the art.

FIG. 2B shows the filament coils 34 wound about the mandrel 12 at about an angle of about plus and minus forty-five degrees relative to the perpendicular axis 46 of the mandrel. For example, the first layer may be wound at an angle of plus forty-five degrees relative to the perpendicular axis 46 while the second layer may be wound at an angle of minus forty-five degrees relative to the perpendicular axis 46.

FIG. 2C shows the filament coils 34 wound about the mandrel 12, for example, at about an angle of about plus and minus seventy degrees relative to the perpendicular axis 46. Note that FIGS. 2A-2C are not necessarily drawn to scale and may not accurately depict the above-mentioned angles. They are shown for purposes of illustration only. Again, adjacent layers are wound at opposing angles. Preferable, the angle of winding adjacent layers is equal but opposite, but need not necessarily be wound in that manner, as will be described below.

Preferably, between five to thirty layers of the filament coils 34 may be wound on the mandrel 12, which may form for example, a sheet of material between about between about one and six millimeters in thickness. Note that an individual layer may be between 0.1 mm to 0.25 mm thick depending on the size of the tow and the amount of spread. Of course, depending upon the application, the material may be formed of any suitable number of layers, and there is no practical limit to its thickness.

Once the desired number of layers of the filament coils 34 have been wound about the mandrel 12, the material is removed from the mandrel The material may be allowed to “mature” or “stage,” which allows the resin to increase in viscosity and makes the material easier to handle. The resin is not allowed to fully cure, as this occurs with the sheet-molded compound charge in the mold. The coils 34 may then be cut along an axis parallel to the longitudinal axis 32 of the mandrel 12, and the resulting material, referred to as a “continuous fiber pre-form” 50 (or “pre-form”), is uncurled and removed from the mandrel. Alternately, specific shapes may be cut from the continuous fiber pre-form while it remains on the mandrel 12. This may be done using mechanical or ultrasonic blades, or a GERBER brand cutter, as is known in the art. A removable thin paper or polyethylene backing sheet may be attached to continuous fiber pre-form material to facilitate handling so that the resin does not stick to or become attached to other objects. The continuous fiber pre-form sheets 50 can then be stacked to facilitate shipping or for transport to another handling or processing location.

The continuous fiber pre-form 50 is an extremely strong and versatile material. The continuous fiber pre-form is extremely strong for a number of reasons, including but not limited to: 1) the structural properties of the base filament material from which it is formed, 2) the adhesion and bonding properties of the resin used to bond the coils 34, 3) the multiple layers of the filament coil 34, and 4) that each layer is applied at an opposing or differing angle.

With respect to the fourth reason mentioned above, as shown in FIG. 2B, a first layer of the coils 34 may be applied at a plus forty-five degree angle while the second layer of the coils 34 may be applied at a minus forty-five degree angle. The angle of each layer alternates so as to form a “criss-cross” pattern. This is analogous to plywood, which has the grain of alternating resin-bonded layers disposed at ninety degrees to an adjacent layer. Accordingly, the continuous fiber pre-form 50 is extremely strong and durable.

Note that each layer of the filament coils 34 need not be wound as a “mirror image” of an adjacent layer. In other words, the opposing angles need not necessarily be equal in magnitude. For example, a first layer may be wound at a plus forty degree angle, while a second layer may be wound at a minus thirty-two degree angle, depending on the specific application. The angle that each layer of filament coils is wound determines its structural properties along particular angles of incident force or stress. The optimum angle of the alternating layers depends upon the application in which the continuous fiber pre-form is to be used, which in turn is governed by the magnitude of expected force and an angle of the expected force applied to the continuous fiber pre-form or molded article.

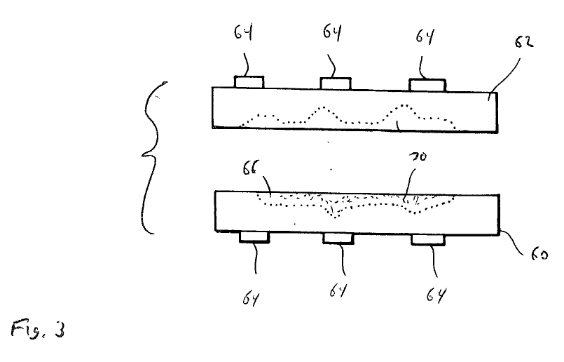

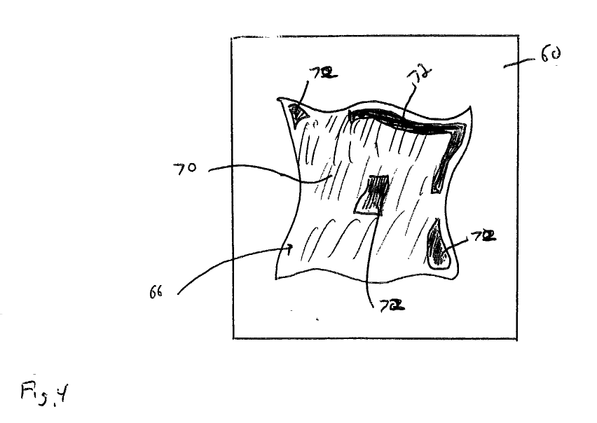

Referring now to FIGS. 3 and 4, FIG. 3 is a side view of a known mold and FIG. 4 is a top plan view of a bottom half 60 of the mold illustrated in FIG. 4. The mold may be of a conventional type as is known in the art, also referred to as “match metal molding.” The mold includes the bottom half 60, a top half 62 and a plurality of heating elements 64. The bottom half 60 contains a void or depression 66 having the shape or contour of the article to be molded. The top half 62 may have a corresponding contour, depending upon the shape or contour of the other side of the article to be molded. To manufacture a desired article, a “charge” or chopped fiber compound 70 is deposited into the mold 60. The chopped fiber compound 70 may be, for example, polyester resin and/or vinyl-ester resin with chopped fiberglass and fillers, as is known in the art. Once the chopped fiber compound 70 has been loaded, the top half 62 and the bottom half 64 are brought together under pressure, and heat is applied by the heating elements 64. The chopped-fiber compound 70 melts and flows within the mold to conform to the shape of the depression 66 corresponding to the shape of the article to be manufactured. The excess chopped fiber compound 70 is trimmed off by shear edges around the perimeter of the part cavity, and when sufficiently cured, the article is removed from the mold. Note that most sheet-molded compound components may be removed from the mold while still relatively hot and because epoxy and polyesters and the like are thermoset materials. Thus, they are sufficiently strong to be removed while hot. Alternatively, a support fixture (not shown) may be used to hold the hot components in the correct shape while they cool down. Manufacturing cycle times may be greatly improved by not cooling the parts in the mold.

However, to provide localized reinforcement to the article to be manufactured, prior to the molding process described immediately above, the continuous fiber pre-form is cut into appropriate sections 72 and placed in the bottom half of the mold 60. It may be placed on top of, in the middle of, or at the bottom of the chopped fiber compound 70, depending upon the desired location within the thickness of the article to be manufactured. The continuous fiber pre-form may also form the entire thickness of the mold. Because the mold 60, 62 is heated and under pressure, the chopped fiber compound 70 melts and flows within the mold and bonds with the continuous fiber pre-form reinforcing sections 72. In one specific embodiment, depending upon the “height” or “depth” of the continuous fiber pre-form reinforcing section 72 within the chopped fiber compound, the continuous fiber pre-form reinforcing sections may be fully “encapsulated” within the bonded chopped fiber compound.

The continuous fiber pre-form reinforcing sections 72 strategically add strength and reinforcement to the manufactured article, while adding minimal weight. Accordingly, lighter, stiffer, stronger and cost-competitive components may be manufactured. Although the continuous fiber pre-form reinforcing material is expensive to manufacture relative to chopped fiber compound articles, the amount or number of the continuous fiber pre-form reinforcing sections 72 is small compared to the size and volume of the chopped fiber compound article manufactured. Thus, use of the continuous fiber pre-form reinforcing sections 72 within the chopped fiber compound sheet-molded article is extremely cost effective. Use of the continuous fiber pre-form reinforcing sections 72 is also very efficient because an article may be manufactured to meet strength and weight requirements that could not otherwise be met using only chopped fiber compound.

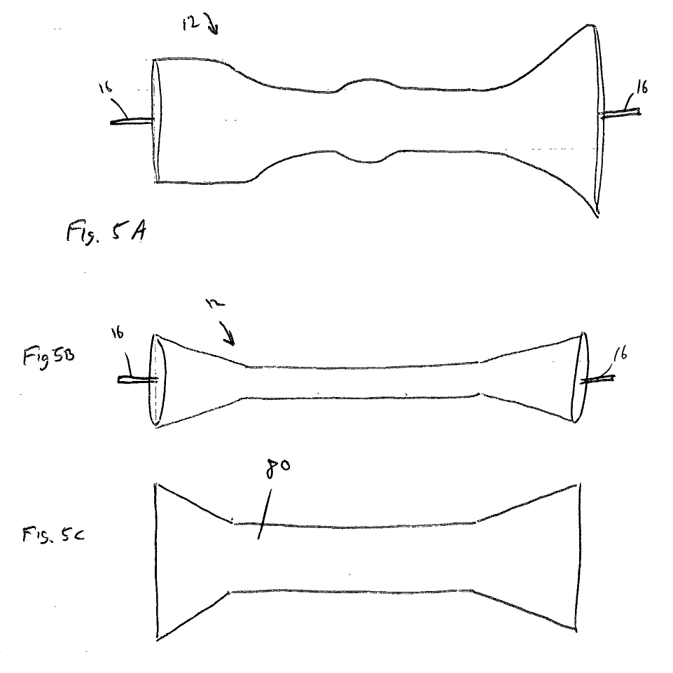

Referring now to FIGS. 5A and 5B, alternate embodiments of a mandrel 12 are shown. To help facilitate formation of the continuous fiber pre-form reinforcing sections 72 having specific curves or bends, the mandrel 12 may have a specific contour, other than purely cylindrical, as shown in the illustrated embodiments of FIGS. 5A and 5B. Accordingly, when the continuous fiber pre-form material is removed from the mandrel 12, it will have specific curves or contours formed therein in accordance with the shape of the mandrel. This may eliminate a step of specifically bending the continuous fiber pre-form sections 72 into the appropriate shape before setting them into the mold. FIG. 5C illustrates the contour of a sheet of the continuous fiber pre-form material 80 removed from the mandrel 12 of FIG. 5B and laid flat. The size and shape of the continuous fiber pre-form reinforcing section placed into the mold 60 depends upon the structural requirements of the article to manufacture.

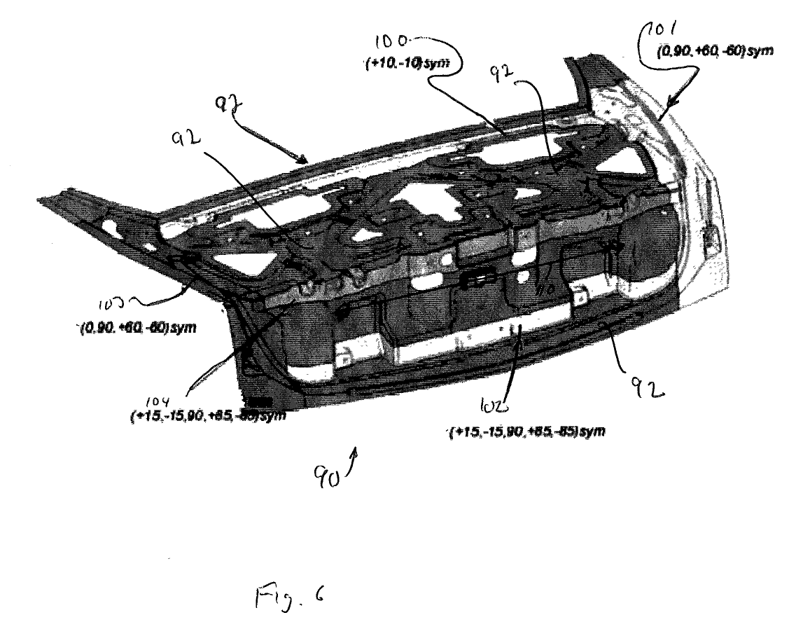

Referring now to FIG. 6, a specific example of a vehicle panel, such as a trunk panel 90, is shown. Most of the trunk panel 90 is formed of sheet molding compound 92. However, in this specific example, five individual sections of continuous fiber pre-form sections 100-104 are additionally incorporated as shown. The trunk panel 90 is economical to manufacture because most of it is formed from sheet molding compound 92 in accordance with process described above. Further, the addition of the continuous fiber pre-form sections 100-104 significantly increase the trunk panel's strength and stiffness, while only minimally increasing the weight of the panel and its manufacturing costs. If a part is designed to use continuous pre-form sections in strategic areas, such a part may have superior performance characteristics and may weigh less. In some instances, cost savings can occur through part consolidation, such as when several parts can be made into a single part because of the increased performance benefits.

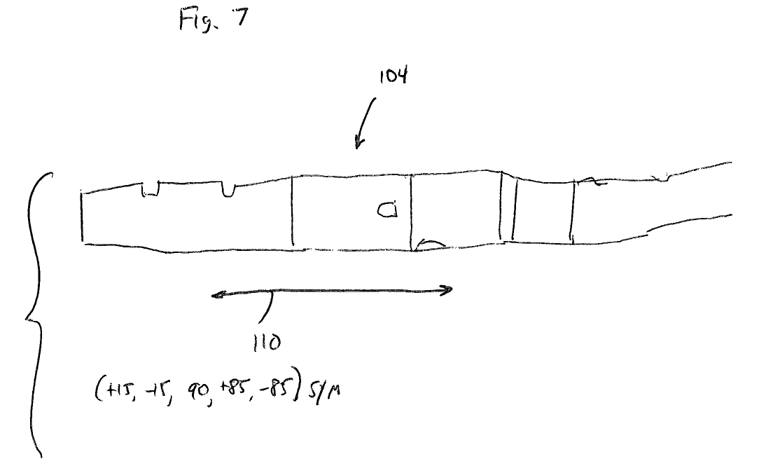

As described above, the continuous fiber pre-form material is initially formed on a mandrel and cut to the appropriate shape, as described above. Accordingly, each continuous fiber pre-form section 100-104 is composed of multiple layers, where each layer may be wound at differing angles. As shown in the illustrated embodiment of FIG. 6, each continuous fiber pre-form section 100-104 is shown having a designation defining the angle of winding of each layer. For example, the continuous fiber pre-form section 104 has the designation “(+15, −15, 90, +85, −85) sym.” Each angle specified is taken relative to an arbitrarily chosen reference angle. For example, the reference angle may be taken as a particular edge of the section 104, as shown in greater detail in FIG. 7. For purposes of this illustration, the reference angle assigned is an edge of the continuous fiber pre-form section 104 and is given a reference designation of 110. Thus, all angle designations are given relative to line or reference angle 110.

Accordingly, the first layer is wound at an angle of +15 degrees relative to the reference angle 110, the second layer is wound at an angle of −15 degrees relative to the reference angle, the third layer is wound at an angle of +90 degrees relative to the reference angle, the fourth layer is wound at an angle of +85 degrees relative to the reference angle, and the fifth layer is wound at an angle of −85 degrees relative to the reference angle.

However, the term “sym” following the angular designations indicates that the continuous fiber pre-form section 104 also includes a “mirror image” of the layers. Thus, a total of ten layers exists in the illustrated example such that the sixth layer is wound at an angle of −85 degrees relative to the reference angle, the seventh layer is wound at an angle of +85 degrees relative to the reference angle, the eighth layer is wound at an angle of +90 degrees relative to the reference angle, the ninth layer is wound at an angle of −15 degrees relative to the reference angle, and the tenth layer is wound at an angle of +15 degrees relative to the reference angle.

Thus, a complete angular designation or “long-hand” nomenclature for the continuous fiber pre-form section 104 is (+15, −15, 90, +85, −85, −85, +85, 90, −15, +15), where each number specifies the angle of winding of the filament in the pre-form section. Such a continuous fiber pre-form section manufactured using this “mirror image” approach is referred to as a “balanced laminate,” and is preferable because it exhibits superior thermal properties with respect to expansion and contraction.

To determine the shape, size, and location of the continuous fiber pre-form section to include in the molding process, the structure to be manufactured is analyzed using conventional finite element analysis techniques, as is known in the art. As is known, finite element analysis breaks down a given structure into a large number of smaller discrete elements or nodes. Each node is analyzed and various assumptions are made. This permits calculations to be made on a complex structure using simplified elements.

In general, the various loads for an article to be manufactured are defined. This may be done empirically using field measurements (strain gauges etc., wind tunnel and the like) or may be based upon known conditions or applied forces, such as weight loading, torque, and the like. The article to be manufactured may be designed to withstand various stresses (breaking force) and/or strains (deflection). Of course, the loading on a particular article to be manufactured differs depending upon the application and the size and shape of the article. However, the analytical approach is similar using a finite element analysis approach. The results of the above analysis are used to identify high-stress areas or low-performing areas of the article to be manufactured. This determines the size and shape of the continuous fiber pre-form sections and also determines the placement of such sections within the mold. For example, if it is determined that a particular edge of a trunk lid for a vehicle experiences high stress along the entire edge, a continuous fiber pre-form section may be incorporated into the mold for the trunk lid along that edge. The location of the stresses along the edge may determine the length and width of the continuous fiber pre-form to incorporate into the mold.

Depending upon the application in which the article to be manufactured is to be used, design criteria may be directed to strain, which involves improving stiffness (i.e., reducing deflection), or such design criteria may be directed to stress, which involves improving the strength or failure parameters of the article. A combination of stress and strain criteria may also be used. Note that the known finite element analysis described above may be implemented using commercially available computer software, as is known in the art.

After the stresses and strains have been quantified, classical laminated plate theory analysis is applied to determine the configuration of the continuous fiber pre-form, meaning, the lamination or winding pattern of the continuous fiber pre-form manufactured on the mandrel, as described above. Again, such classical laminated plate theory analysis is known to one skilled in the art, and the specific details of which are not explained herein. It is sufficient to describe that the nature and characteristics of the determined stresses and strains dictate the configuration of the winding pattern of the continuous fiber pre-form sections. Once the laminate orientation has been defined, the material properties of the laminate can then be replaced back into the finite element model. The results of the analysis may verify that the desired performance characteristics can now be met. If the results are less than desired, the newly predicted stresses and strains can be used along with the laminated plate theory analysis to determine an even better laminate orientation. This process is iterative by nature.

For example, if the stresses and strains on a particular portion of an article are homogenous and isotropic, meaning that the stresses and strains are equal in all directions and do not change with respect to location, then an “isotropic” winding pattern may be used. For example, eight layers may be wound to form the continuous fiber pre-form, where each layer is wound at a forty-five degree offset from the previous layer. Such a configuration, for example, may exhibit nearly equal strength and stiffness in all directions. This is an example of a quasi-isotropic laminate.

Alternately, for example, a leaf-spring for a vehicle may be manufactured using the above-described continuous fiber pre-form techniques. However, in the specific example of a leaf-spring, no sheet molding compound would be used, and the entire leaf-spring may be formed entirely from multiple layers of the continuous fiber pre-form. In this case, each and every layer of the pre-form may be wound such that the filaments are aligned at a zero degree angle relative to a longitudinal axis of the leaf-spring. Because all of the forces tend to bend the leaf-spring along its longitudinal axis, and virtually no shearing forces are applied laterally across its width, all of the layers of the continuous fiber pre-form may be aligned in the same direction.

Various lamination configurations are shown in FIG. 6 for five specific continuous fiber pre-form sections 100-104 of an exemplary trunk lid. Note that the first continuous fiber pre-form section 100 includes four layers wound at plus and minus ten degrees, the second section 101 includes eight layers, the third layer 102 includes ten layers, the fourth layer 103 includes eight layers, and the fifth layer 104 includes ten layers. The different angular values for the windings of the continuous fiber pre-form sections 100-104 may be determined in accordance with the above-described classical plate theory analysis.

Specific embodiments of a method of manufacturing a sheet-molded compound article having localized reinforcement according to the present invention have been described for the purpose of illustrating the manner in which the invention may be made and used. It should be understood that implementation of other variations and modifications of the invention and its various aspects will be apparent to those skilled in the art, and that the invention is not limited by the specific embodiments described. It is therefore contemplated to cover by the present invention any and all modifications, variations, or equivalents that fall within the true spirit and scope of the basic underlying principles disclosed and claimed herein.

What is claimed is:

1. A method of manufacturing a sheet-molded compound (SMC) article having local reinforcement, the method comprising the steps of:
a. providing a mold for forming the SMC article;
b. filling a portion of the mold with a chopped fiber compound;
c. placing at least one filament-wound reinforcing element a position in the mold where structural reinforcement of the SMC article is needed;
d. the reinforcing element formed by the steps of:
1. winding a resin-coated filament on a mandrel to form a plurality of coils along a length of the mandrel, each coil wound at a predetermined angle relative to an axis of the mandrel;
2. forming a plurality of layers of said coils with adjacent layers being wound at opposing angles, said layers forming a filament-wound pre-form;
3. cutting a portion of the filament-wound pre-form in a predetermined shape to form the reinforcing element;
e. applying heat and pressure to the mold to cause the chopped fiber compound to melt, said melted chopped fiber compound bonding with the reinforcing element to form the SMC article with local reinforcement; and
f. removing the SMC article with local reinforcement from the mold.

2. The method according to claim 1 wherein the step of placing the reinforcing element in the mold further includes the steps of:
determining structural requirements of the SMC molded article;
determining locations on the SMC article that are subject to high structural stress; and
determining a shape of the reinforcing element adapted to withstand said high structural stress.

3. The method according to claim 1 wherein the opposing angles of the adjacent layers of the filament-wound pre-form are determined according to a magnitude of expected force and an angle of the expected force applied to the molded article in the region of the reinforcing element.

4. The method according to claim 1 wherein the opposing angles of the adjacent layers of the filament-wound pre-form are determined using classical plate theory analysis.

5. The method according to claim 1 wherein the chopped fiber compound is made of material selected from the group consisting of polyester resin, vinyl-ester resin, epoxy, thermoset material, and thermoplastic material.

6. The method according to claim 1 wherein the chopped fiber compound further includes a filler material made of calcium carbonate.

7. The method according to claim 1 wherein the filament is made of material selected from the group consisting of e/glass fibers, glass fibers, fiberglass, carbon fiber, and Kevlar fiber.

8. The method according to claim 1 wherein the filament is coated with a resin that is made of material selected from the group consisting epoxy, vinyl-ester, and polyester.

9. The method according to claim 1 wherein the filament-wound pre-form is formed from multiple layers of the coils.

10. The method according to claim 1 wherein the filament-wound pre-form is about between five and fifteen millimeters in thickness.

11. The method according to claim 1 wherein the filament-wound pre-form is about between 0.2 and 8 millimeters in thickness.

12. The method according to claim 1 wherein the angle of the coils of one layer relative to an adjacent layers of the filament-wound pre-form is about between zero degrees and ninety degrees.

13. The method according to claim 1 wherein the angle of the coils of one layer is substantially equal in magnitude and opposite in sign relative to an adjacent layer.

14. The method according to claim 1 wherein the angle of the coils of adjacent layers are not equal in magnitude.

15. The method according to claim 1 wherein a plurality of filament-wound reinforcing elements are placed in the mold to provide structural reinforcement at selected locations within article.

16. The method according to claim 1 wherein a plurality of filament-wound reinforcing elements is placed about a peripheral edge of the article.

17. A method of manufacturing a sheet-molded compound (SMC) article having local reinforcement, the method comprising the steps of:
a. providing a mold for forming the SMC article;
b. filling a portion of the mold with a chopped fiber compound;
c. placing at least one filament-wound reinforcing element in a position in the mold where structural reinforcement of the SMC article is needed;
d. the reinforcing element formed by an apparatus having:
1. means for winding a resin-coated filament on a mandrel to form coils along a length of the mandrel, each coil wound at a predetermined angle relative to an axis of the mandrel;
2. means for forming a plurality of layers of said coils with adjacent layers being wound at predetermined angles, said layers forming a filament-wound preform;
3. means for cutting a portion of the filament-wound pre-form in a predetermined shape to form the reinforcing element;
e. applying heat and pressure to the mold to cause the chopped fiber compound to melt, said melted chopped fiber compound bonding with the reinforcing element to form the SMC article with local reinforcement; and
f. removing the SMC article with local reinforcement from the mold.

18. A method of manufacturing a sheet-molded compound (SMC) article having local reinforcement, the method comprising the steps of:
providing a mold for forming the SMC article;
filling a portion of the mold with a chopped fiber compound;
placing at least one filament-wound reinforcing element a position in the mold where structural reinforcement of the SMC article is needed;
applying heat and pressure to the mold to cause the chopped fiber compound to melt, said melted chopped fiber compound bonding with the reinforcing element to form the SMC article with local reinforcement; and
removing the SMC article with locally reinforced from the mold.

19. The method according to claim 17 wherein forming the reinforcing element further includes the steps of:
winding a resin-coated filament on a mandrel to form coils along a length of the mandrel, each coil wound at a predetermined angle relative to an axis of the mandrel;
forming a plurality of layers of said coils with adjacent layers being wound at predetermined angles, said layers forming a filament-wound pre-form; and
cutting a portion of the filament-wound pre-form in a predetermined shape to form the reinforcing element;
